(19) United States
(12) Patent Application Publication
(10) Pub. No.: US 2020/0041850 A1
(43) Pub. Date: Feb. 6, 2020

(54) DISPLAY PANEL AND METHOD OF MANUFACTURING THE SAME

(71) Applicant: HKC CORPORATION LIMITED, Shenzhen (CN)

(72) Inventor: CHUNG-KUANG CHIEN, (US)

(21) Appl. No.: 15/739,999

(22) PCT Filed: Jul. 3, 2017
(86) PCT No.: PCT/CN2017/091404

§ 371 Date: Dec. 27, 2017

(30) Foreign Application Priority Data
Mar. 3, 2017 (CN) 201710122582.4

(51) Int. Cl. G02F 1/1337; G02F 1/1339; G02F 1/1335

(52) U.S. Cl. CPC G02F 1/133784; G02F 1/1339; G02F 1/133528; G02F 1/133514; G02F 1/133512

(57) ABSTRACT

A display panel and a method of manufacturing the same are provided. The display panel includes a substrate and a composite material layer. The composite material layer is disposed on an inner surface of the substrate. The composite material layer includes a polarizing layer having a polarization function and an alignment layer coated on a surface of the polarizing layer.

### CROSS-REFERENCE TO RELATED APPLICATION

This application claims the benefit of China Patent Application No. 201710122582.4, filed on Mar. 3, 2017, in the State Intellectual Property Office of the People's Republic of China, the disclosure of which is incorporated herein in its entirety by reference.

### FIELD OF THE INVENTION

The present invention relates to the display technology, and more particularly to a display panel and a method of manufacturing the same.

### BACKGROUND OF THE INVENTION

A liquid crystal display has the advantages of a thin body, energy-saving, no radiation and so on. Therefore, it has been widely used. Most of the liquid crystal displays on the market are in the form of backlight, including a liquid crystal panel and a backlight module. The liquid crystal panel includes two parallel glass substrates and liquid crystals disposed between the two parallel glass substrates. The two glass substrates are applied with a driving voltage for controlling the direction of rotation of the liquid crystals to reflect the light from the backlight module so as to produce a picture.

A thin film transistor liquid crystal display (TFT-LCD) is now in a dominant position in the display field because of its low power consumption, excellent picture quality, high production yield, and other performances. Similarly, the thin film transistor liquid crystal display includes a liquid crystal panel and a backlight module. The liquid crystal panel includes a color filter substrate (CF substrate), a thin film transistor substrate (TFT substrate), and a mask. A transparent electrode is provided between opposite inner sides of the two substrates. A layer of liquid crystals is sandwiched between the two substrates.

Thin film transistor liquid crystal displays are gradually developed toward large size, high drive frequency, high resolution, and so on. For the production of thin film transistor liquid crystal displays, how to make a display thinner and how to simplify the manufacturing method not only affect the process quality and efficiency of the display panel but also determine the production cost.

### SUMMARY OF THE INVENTION

The primary object of the present invention is to provide a display panel having a polarization effect, and a method of manufacturing the same, and a display device.

According to one aspect of the present invention, a display panel is provided. The display panel comprises a substrate and a composite material layer. The composite material layer is disposed on an inner surface of the substrate. The composite material layer includes a polarizing layer having a polarization function and an alignment layer coated on a surface of the polarizing layer.

Preferably, the substrate includes a first substrate and a second substrate. A thin film transistor is provided on the first substrate. The first substrate faces the second substrate. The first substrate is provided with the composite material layer close to an inner surface of the second substrate. The second substrate is provided with an alignment film close to an inner surface of the first substrate. An outer surface of the second substrate is provided with a polarizer. The inner surface of one of the two substrates is provided with the composite material layer having the polarization effect and the alignment capability. The other substrate is coated with a conventional alignment film (polyimide, PI) as a means for forming the composite material layer.

Alternatively, the substrate includes a first substrate and a second substrate. A thin film transistor is provided on the first substrate. The first substrate faces the second substrate. The second substrate is provided with the composite material layer close to an inner surface of the first substrate. The first substrate is provided with an alignment film close to an inner surface of the second substrate. An outer surface of the first substrate is provided with a polarizer. The inner surface of one of the two substrates is provided with the composite material layer having the polarization effect and the alignment capability. The other substrate is coated with a conventional alignment film (polyimide, PI) as a means for forming the composite material layer.

Alternatively, the substrate includes a first substrate and a second substrate. The first substrate faces the second substrate. The first substrate is provided with the composite material layer close to an inner surface of the second substrate. The second substrate is provided with the composite material layer close to an inner surface of the first substrate. The opposite inner surfaces of the two substrates are provided with the respective composite material layers having the polarization effect and the alignment capability so that both sides of the display panel have polarization capability.

Preferably, a photo spacer and liquid crystals are provided between the two substrates. The substrate includes the first substrate and the second substrate. The thin film transistor is provided on the first substrate. A color filter and a black matrix are provided on the second substrate. The first substrate with the thin film transistor may function as a thin film transistor substrate (TFT substrate). The second substrate with the color filter may function as a color filter substrate (CF Substrate). The photo spacer (PS) between the two substrates allows the two substrates to be kept at a certain interval. The black matrix (BM) is used to prevent backlight leakage, thereby improving display contrast and preventing color mixing and increasing the purity of color.

According to another aspect of the present invention, a method of manufacturing a display panel is provided. The display panel includes a substrate. The method includes the steps of: applying a composite material layer on the substrate; and processing polarization and alignment distribution of the composite material layer. Wherein, the composite material layer includes a polarizing layer having a polarization function and an alignment layer coated on a surface of the polarizing layer.

Preferably, the polarization and alignment distribution of the composite material layer is processed by laser. In the change mechanism for a photo alignment material to form an alignment film, the photolysis mechanism is used to mix polyimide (PI) to form the photo alignment material, thereby having stability and the alignment stability. It is convenient to get laser, and laser has directional light and high brightness.

Preferably, the display panel includes a transparent conductive layer. The polarization and alignment distribution of the composite material layer is processed by applying a driving voltage to the transparent conductive layer. An embodiment of the polarization and alignment distribution of the composite material layer is achieved by using the original structural characteristics of the panel.

Alternatively, the polarization and alignment distribution of the composite material layer is processed by rubbing. A flannel roller is used to get contact with the surface of the polymer polyimide for performing forward mechanical rubbing. The energy supplied by rubbing the surface of the polymer enables the main chain of the polymer to extend and to be aligned forward to achieve the method of the liquid crystal alignment.

This technology has the advantages described below. The operating time of rubbing is very short, and it can be operated at a normal temperature, and it has the characteristics of excellent production.

According to a further aspect of the present invention, a display device is provided. The display device includes a backlight module and a display panel.

The composite material layer of the present invention is composed of the polarizing layer having the polarization function and the alignment film coated on the surface of the polarizing layer, so that the steps in the method of manufacturing the display panel and the adhesion of the polarizer in the display device after assembled can be omitted to reduce the process and lower the material cost.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic view of a display panel in accordance with an embodiment of the present invention;

FIG. 2 is a schematic view of a display panel in accordance with another embodiment of the present invention;

FIG. 3 is a schematic view of a display panel in accordance with a further embodiment of the present invention;

FIG. 4 is a flow chart of a method of manufacturing a display panel in accordance with an embodiment of the present invention;

FIG. 5 is a schematic view of a substrate at one side of a display panel in accordance with an embodiment of the present invention; and

FIG. 6 is a schematic view of a substrate at one side of a display panel in accordance with another embodiment of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

Throughout the description of the present disclosure, spatially relative terms, such as “center,” “transverse,” “upper,” “lower,” “left,” “right,” “front,” “rear,” “vertical,” “horizontal,” “top,” “bottom,” “inner,” “outer” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. It will be understood that, although the terms “first,” “second” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Throughout the description of the present disclosure, unless the context clearly indicates otherwise, the meaning of “plural” is two or more. In addition, the terms “comprise,” “comprising,” “includes,” “including,” and the like are intended to cover non-exclusive inclusion.

Throughout the description of the present disclosure, it should be understood that the terms “installed,” “connected,” and “coupled” should be broadly interpreted, unless the context clearly indicates otherwise, for example, it may be fixedly connected, detachably connected, or integrally connected; it be a mechanically connected or electrically connected; it may be directly connected or indirectly connected through an intermediate medium; it be an internal connection of two components. It will be apparent to those skilled in the art that the specific meaning of the above terms in this description.

The terminology used herein is for the purpose of describing particular embodiments only and is not intended to be limiting of the present invention. As used herein, the singular forms “a,” “an,” and “the” are intended to include the plural form s as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

Embodiments of the present invention will now be described, by way of example only, with reference to the accompanying drawings.

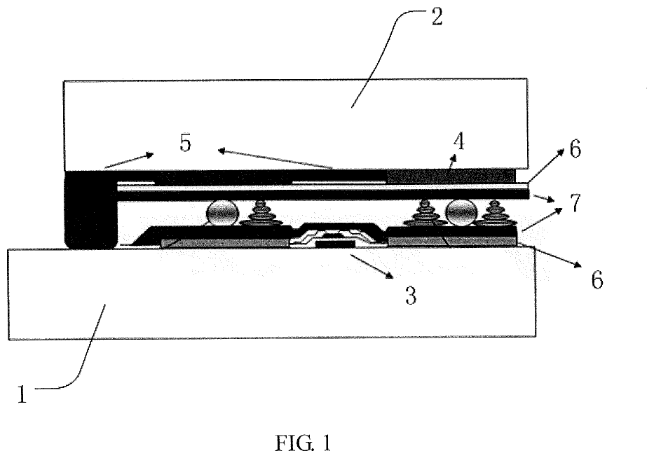

As shown in FIG. 1, the display panel in accordance with an embodiment of the present invention includes a substrate and a composite material layer 7. The composite material layer 7 is disposed on an inner surface of the substrate. The composite material layer 7 includes a polarizing layer having a polarization function and an alignment layer coated on the surface of the polarizing layer. The substrate includes a first substrate 1 and a second substrate 2. The first substrate 1 faces the second substrate 2. The first substrate 1 is provided with the composite material layer 7 close to an inner surface of the second substrate 2. The second substrate 2 is provided with the composite material layer 7 close to an inner surface of the first substrate 1. In this embodiment, since the composite material layer 7 is composed of a polarizing layer having a polarization function and an alignment film coated on the surface of the polarizing layer, the steps in the method of manufacturing the display panel and the adhesion of the polarizer in the display device after assembled can be omitted to reduce the process and lower the material cost.

Specifically, a photo spacer and liquid crystals are provided between the two substrates. The substrate includes a first substrate 1 and a second substrate 2. A thin film transistor 3 is provided on the first substrate 1. A color filter 4 and a black matrix 5 are provided on the second substrate 2. The first substrate 1 with the thin film transistor (TFT) 3 may function as a thin film transistor substrate (TFT substrate). The second substrate 2 with the color filter 4 may function as a color filter substrate (CF Substrate). The photo spacer (PS) between the two substrates allows the two substrates to be kept at a certain interval. The black matrix (BM) 5 is used to prevent backlight leakage, thereby improving display contrast and preventing color mixing and increasing the purity of color.

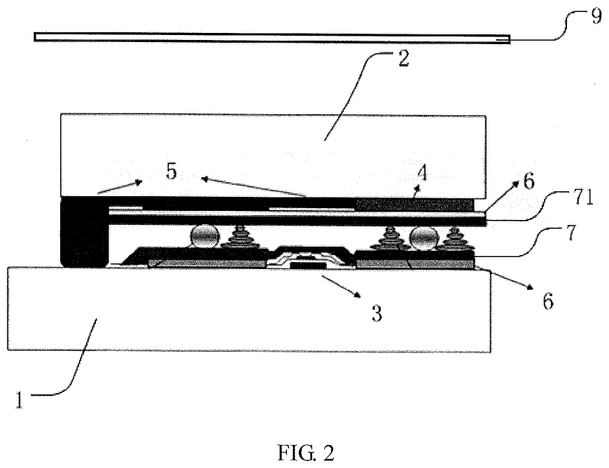

As shown in FIG. 2, the display panel in accordance with an embodiment of the present invention includes a substrate and a composite material layer 7. The composite material layer 7 is disposed on an inner surface of the substrate. The composite material layer 7 includes a polarizing layer having a polarization function and an alignment layer coated on the surface of the polarizing layer. The substrate includes a first substrate and a second substrate. A thin film transistor is provided on the first substrate. The first substrate faces the second substrate. The first substrate is provided with the composite material layer close to an inner surface of the second substrate. The second substrate is provided with an alignment film 71 close to an inner surface of the first substrate. An outer surface of the second substrate is provided with a polarizer. The inner surface of one of the two substrates is provided with the composite material layer 7 having the polarization effect and the alignment capability. The other substrate is coated with a conventional alignment film (polyimide, PI) as a means for forming the composite material layer 7. The composite material layer 7 includes the polarizing layer having a polarization function and the alignment film 71 coated on the surface of the polarizing layer, so that the steps in the method of manufacturing the display panel and the adhesion of the polarizer in the display device after assembled can be omitted to reduce the process and lower the material cost.

Specifically, a photo spacer and liquid crystals are provided between the two substrates. The substrate includes a first substrate 1 and a second substrate 2. A thin film transistor 3 is provided on the first substrate 1. A color filter 4 and a black matrix 5 are provided on the second substrate 2. The first substrate 1 with the thin film transistor (TFT) 3 may function as a thin film transistor substrate (TFT substrate). The second substrate 2 with the color filter 4 may function as a color filter substrate (CF Substrate). The photo spacer (PS) between the two substrates allows the two substrates to be kept at a certain interval. The black matrix (BM) 5 is used to prevent backlight leakage, thereby improving display contrast and preventing color mixing and increasing the purity of color.

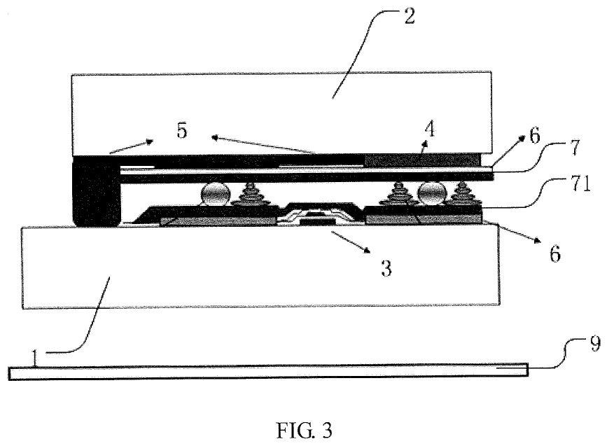

As shown in FIG. 3, the display panel in accordance with an embodiment of the present invention includes a substrate and a composite material layer 7. The composite material layer 7 is disposed on an inner surface of the substrate. The composite material layer 7 includes a polarizing layer having a polarization function and an alignment layer coated on the surface of the polarizing layer. The substrate includes a first substrate and a second substrate. A thin film transistor is provided on the first substrate. The first substrate faces the second substrate. The second substrate is provided with the composite material layer close to an inner surface of the first substrate. The first substrate is provided with an alignment film 71 close to an inner surface of the second substrate. An outer surface of the first substrate is provided with a polarizer. The inner surface of one of the two substrates is provided with the composite material layer 7 having the polarization effect and the alignment capability. The other substrate is coated with a conventional alignment film (polyimide, PI) as a means for forming the composite material layer 7. The composite material layer 7 includes the polarizing layer having a polarization function and the alignment film 71 coated on the surface of the polarizing layer, so that the steps in the method of manufacturing the display panel and the adhesion of the polarizer in the display device after assembled can be omitted to reduce the process and lower the material cost.

Specifically, a photo spacer and liquid crystals are provided between the two substrates. The substrate includes a first substrate 1 and a second substrate 2. A thin film transistor 3 is provided on the first substrate 1. A color filter 4 and a black matrix 5 are provided on the second substrate 2. The first substrate 1 with the thin film transistor (TFT) 3 may function as a thin film transistor substrate (TFT substrate). The second substrate 2 with the color filter 4 may function as a color filter substrate (CF Substrate). The photo spacer (PS) between the two substrates allows the two substrates to be kept at a certain interval. The black matrix (BM) 5 is used to prevent backlight leakage, thereby improving display contrast and preventing color mixing and increasing the purity of color.

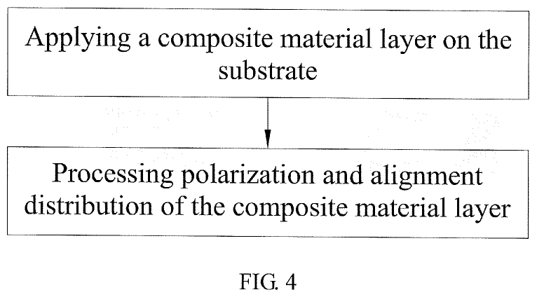

As shown in FIG. 4, the display panel in accordance with an embodiment of the present invention includes a substrate. A method of manufacturing the display panel includes the steps of:

applying a composite material layer 7 on the substrate; and

processing polarization and alignment distribution of the composite material layer 7.

The composite material layer 7 includes a polarizing layer having a polarization function and an alignment layer coated on the surface of the polarizing layer.

Since the material having the alignment property often has high polarization, high water absorption, and tends to be deteriorated during storage or transportation to result in uneven alignment, so that the step B is required. After that, it is necessary to distribute the photo spacer (PS) between the two substrates to keep the two substrates spaced apart so that the cell is formed. For the display panel used as a liquid crystal panel, the inside of the liquid crystal cell is vacuumed and then injected with liquid crystals (LC). Afterwards, a liquid crystal display is assembled.

According to still another embodiment of the present invention, the display panel includes a substrate. A method of manufacturing the display panel includes the steps of: applying a composite material layer 7 on the substrate; and processing polarization and alignment distribution of the composite material layer 7 by laser. In the change mechanism for a photo alignment material to form an alignment film, the photolysis mechanism is used to mix polyimide (PI) to form the photo alignment material, thereby having stability and the alignment stability. It is convenient to get laser, and laser has directional light and high brightness.

The composite material layer 7 is processed with polarization and alignment distribution by laser.

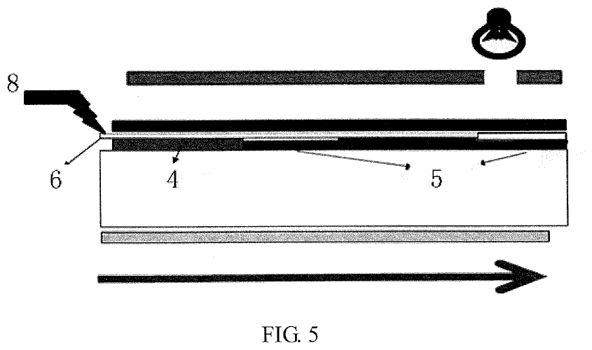

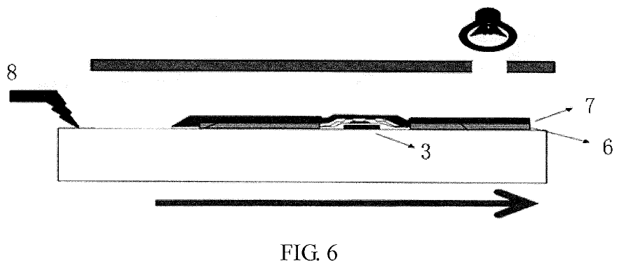

As shown in FIG. 5 and FIG. 6, the display panel in accordance with an embodiment of the present invention includes a substrate. A method of manufacturing the display panel includes the steps of: applying a composite material layer 7 on the substrate; the display panel including a transparent conductive layer 6, processing polarization and alignment distribution of the composite material layer 7 by applying a driving voltage 8 to the transparent conductive layer 6. An embodiment of the polarization and alignment distribution of the composite material layer 7 is achieved by using the original structural characteristics of the panel.

Wherein, the composite material layer 7 is processed with polarization and alignment distribution by applying the driving voltage 8 to the transparent conductive layer 6.

Wherein, FIG. 5 illustrates the polarization and alignment distribution of the composite material layer 7 when the second substrate 2 functions as the color filter substrate. After the transparent conductive layer 6 is communicated with the driving voltage 8, the composite material layer 7 embodies the alignment capability. The liquid crystals are sequentially arranged in the direction of the arrow in FIG. 5.

Wherein, FIG. 6 illustrates the polarization and alignment distribution of the composite material layer 7 when the first substrate 1 functions as the thin film transistor substrate. After the transparent conductive layer 6 is communicated with the driving voltage 8, the composite material layer 7 embodies the alignment capability. The liquid crystals are sequentially arranged in the direction of the arrow in FIG. 6.

According to still another embodiment of the present invention, the display panel includes a substrate. A method of manufacturing the display panel includes the steps of: applying a composite material layer 7 on the substrate; and processing polarization and alignment distribution of the composite material layer 7 by rubbing. A flannel roller is used to get contact with the surface of the polymer polyimide for performing forward mechanical rubbing. The energy supplied by rubbing the surface of the polymer enables the main chain of the polymer to extend and to be aligned forward to achieve the method of the liquid crystal alignment. This technology has the advantages described below. The operating time of rubbing is very short, and it can be operated at a normal temperature, and it has the characteristics of excellent production.

The composite material layer is processed with polarization and alignment distribution by rubbing.

A display device according to still another embodiment of the present invention includes a backlight module and a display panel. The display panel includes a substrate and a composite material layer 7. The composite material layer 7 is disposed on an inner surface of the substrate. The composite material layer 7 includes a polarizing layer having a polarization function and an alignment layer coated on the surface of the polarizing layer.

Specifically, the substrate includes a first substrate and a second substrate. A thin film transistor is provided on the first substrate. The first substrate faces the second substrate. The first substrate is provided with the composite material layer close to an inner surface of the second substrate. The second substrate is provided with an alignment film close to an inner surface of the first substrate. An outer surface of the second substrate is provided with a polarizer. The inner surface of one of the two substrates is provided with the composite material layer having the polarization effect and the alignment capability. The other substrate is coated with a conventional alignment film (polyimide, PI) as a means for forming the composite material layer. The display panel has the polarization function at one side of the substrate having the composite material layer 7, so that there is no need for the polarizers to be adhered to both sides of the substrate after the cell is assembled, thereby reducing the process and lowering the material cost.

Specifically, the substrate includes a first substrate and a second substrate. A thin film transistor is provided on the first substrate. The first substrate faces the second substrate. The second substrate is provided with the composite material layer close to an inner surface of the first substrate. The first substrate is provided with an alignment film close to an inner surface of the second substrate. An outer surface of the first substrate is provided with a polarizer. The inner surface of one of the two substrates is provided with the composite material layer having the polarization effect and the alignment capability. The other substrate is coated with a conventional alignment film (polyimide, PI) as a means for forming the composite material layer. The display panel has the polarization function at one side of the substrate having the composite material layer 7, so that there is no need for the polarizers to be adhered to both sides of the substrate after the cell is assembled, thereby reducing the process and lowering the material cost.

Specifically, the substrate includes a first substrate and a second substrate. The first substrate faces the second substrate. The first substrate is provided with the composite material layer close to an inner surface of the second substrate. The second substrate is provided with the composite material layer close to an inner surface of the first substrate, as a means for forming the composite material layer. The opposite inner surfaces of the two substrates are provided with the composite material layers having the polarization effect and the alignment capability, so that both sides of the display panel have the polarization capability. There is no need for the polarizers to be adhered to both sides of the substrate after the cell is assembled, thereby reducing the process and lowering the material cost.

It is to be noted that in the aforesaid embodiments, the material of the substrate may be glass, plastic, or the like.

In the aforesaid embodiments, the color filter substrate may include the thin film transistor (TFT). The color filter and the thin film transistor (TFT) may be formed on the same substrate. The thin film transistor substrate may include the color filter.

In the aforesaid embodiments, the display panel of the present invention may be a curved panel.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A display panel, comprising:
a substrate; and
a composite material layer disposed on an inner surface of the substrate, wherein the composite material layer comprises a polarizing layer having a polarization function and an alignment layer coated on a surface of the polarizing layer;
wherein the substrate comprises a first substrate and a second substrate, a thin film transistor is provided on the first substrate, the first substrate faces the second substrate, the first substrate is provided with the composite material layer close to an inner surface of the second substrate, the second substrate is provided with an alignment film close to an inner surface of the first substrate, an outer surface of the second substrate is provided with a polarizer; or the substrate comprises the first substrate and the second substrate, the thin film transistor is provided on the first substrate, the first substrate faces the second substrate, the second substrate is provided with the composite material layer close to the inner surface of the first substrate, the first substrate is provided with the alignment film close to the inner surface of the second substrate, the outer surface of the first substrate is provided with the polarizer; or the substrate comprises the first substrate and the second substrate, the first substrate faces the second substrate, the first substrate is provided with the composite material layer close to the inner surface of the second substrate, the second substrate is provided with the composite material layer close to the inner surface of the first substrate;
wherein a photo spacer and liquid crystals are provided between the two substrates, the substrate comprises the first substrate and the second substrate, the thin film transistor is provided on the first substrate, a color filter and a black matrix are provided on the second substrate.

2. A display panel, comprising:
a substrate; and
a composite material layer disposed on an inner surface of the substrate, wherein the composite material layer comprises a polarizing layer having a polarization function and an alignment layer coated on a surface of the polarizing layer.

3. The display panel as claimed in claim 2, wherein the substrate comprises a first substrate and a second substrate, a thin film transistor is provided on the first substrate, the first substrate faces the second substrate, the first substrate is provided with the composite material layer close to an inner surface of the second substrate, the second substrate is provided with an alignment film close to an inner surface of the first substrate, and an outer surface of the second substrate is provided with a polarizer.

4. The display panel as claimed in claim 2, wherein the substrate comprises a first substrate and a second substrate, a thin film transistor is provided on the first substrate, the first substrate faces the second substrate, the second substrate is provided with the composite material layer close to an inner surface of the first substrate, the first substrate is provided with an alignment film close to an inner surface of the second substrate, and an outer surface of the first substrate is provided with a polarizer.

5. The display panel as claimed in claim 2, wherein the substrate comprises a first substrate and a second substrate, the first substrate faces the second substrate, the first substrate is provided with the composite material layer close to an inner surface of the second substrate, and the second substrate is provided with the composite material layer close to an inner surface of the first substrate.

6. The display panel as claimed in claim 2, wherein a photo spacer and liquid crystals are further provided between the two substrates, the substrate comprises a first substrate and a second substrate, a thin film transistor is provided on the first substrate, a color filter and a black matrix are provided on the second substrate.

7. The display panel as claimed in claim 3, wherein a photo spacer and liquid crystals are provided between the two substrates, the substrate comprises a first substrate and a second substrate, a thin film transistor is provided on the first substrate, a color filter and a black matrix are provided on the second substrate.

8. The display panel as claimed in claim 2, wherein the substrate comprises a first substrate and a second substrate, a thin film transistor is provided on the first substrate, the first substrate faces the second substrate, the first substrate is provided with the composite material layer close to an inner surface of the second substrate, the second substrate is provided with an alignment film close to an inner surface of the first substrate, an outer surface of the second substrate is provided with a polarizer; a photo spacer and liquid crystals are provided between the two substrates, the substrate comprises the first substrate and the second substrate, the thin film transistor is provided on the first substrate, a color filter and a black matrix are provided on the second substrate.

9. The display panel as claimed in claim 4, wherein a photo spacer and liquid crystals are provided between the two substrates, the substrate comprises the first substrate and the second substrate, the thin film transistor is provided on the first substrate, a color filter and a black matrix are provided on the second substrate.

10. The display panel as claimed in claim 2, wherein the substrate comprises a first substrate and a second substrate, a thin film transistor is provided on the first substrate, the first substrate faces the second substrate, the second substrate is provided with the composite material layer close to an inner surface of the first substrate, the first substrate is provided with an alignment film close to an inner surface of the second substrate, an outer surface of the first substrate is provided with a polarizer; a photo spacer and liquid crystals are provided between the two substrates, the substrate comprises the first substrate and the second substrate, the thin film transistor is provided on the first substrate, a color filter and a black matrix are provided on the second substrate.

11. The display panel as claimed in claim 5, wherein a photo spacer and liquid crystals are provided between the two substrates, the substrate comprises the first substrate and the second substrate, a thin film transistor is provided on the first substrate, a color filter and a black matrix are provided on the second substrate.

12. The display panel as claimed in claim 2, wherein the substrate comprises a first substrate and a second substrate, the first substrate faces the second substrate, the first substrate is provided with the composite material layer close to an inner surface of the second substrate, the second substrate is provided with the composite material layer close to an inner surface of the first substrate; wherein a photo spacer and liquid crystals are provided between the two substrates, the substrate comprises the first substrate and the second substrate, a thin film transistor is provided on the first substrate, a color filter and a black matrix are provided on the second substrate.

13. The display panel as claimed in claim 2, wherein the substrate comprises a first substrate and a second substrate, a thin film transistor is provided on the first substrate, the first substrate faces the second substrate, the first substrate is provided with the composite material layer close to an inner surface of the second substrate, the second substrate is provided with an alignment film close to an inner surface of the first substrate, an outer surface of the second substrate is provided with a polarizer; or the substrate comprises a first substrate and a second substrate, a thin film transistor is provided on the first substrate, the first substrate faces the second substrate, the second substrate is provided with the composite material layer close to an inner surface of the first substrate, the first substrate is provided with an alignment film close to an inner surface of the second substrate, an outer surface of the first substrate is provided with a polarizer; or the substrate comprises a first substrate and a second substrate, the first substrate faces the second substrate, the first substrate is provided with the composite material layer close to an inner surface of the second substrate, the second substrate is provided with the composite material layer close to an inner surface of the first substrate;
wherein a photo spacer and liquid crystals are provided between the two substrates, the substrate comprises the first substrate and the second substrate, the thin film transistor is provided on the first substrate, a color filter and a black matrix are provided on the second substrate.

14. A method of manufacturing a display panel, the display panel comprising a substrate, the method comprising the steps of:
applying a composite material layer on the substrate; and
processing polarization and alignment distribution of the composite material layer;
wherein the composite material layer comprises a polarizing layer having a polarization function and an alignment layer coated on a surface of the polarizing layer.

15. The method as claimed in claim 14, wherein the polarization and alignment distribution of the composite material layer is processed by laser.

16. The method as claimed in claim 14, wherein the display panel comprises a transparent conductive layer, and the polarization and alignment distribution of the composite material layer is processed by applying a driving voltage to the transparent conductive layer.

17. The method as claimed in claim 14, wherein the polarization and alignment distribution of the composite material layer is processed by laser; the display panel comprises a transparent conductive layer, and the polarization and alignment distribution of the composite material layer is processed by applying a driving voltage to the transparent conductive layer.

18. The method as claimed in claim 14, wherein the polarization and alignment distribution of the composite material layer is processed by rubbing.

19. The method as claimed in claim 14, wherein the polarization and alignment distribution of the composite material layer is processed by laser; and the polarization and alignment distribution of the composite material layer is processed by rubbing.

20. The method as claimed in claim 14, wherein the polarization and alignment distribution of the composite material layer is processed by laser; the display panel comprises a transparent conductive layer, the polarization and alignment distribution of the composite material layer is processed by applying a driving voltage to the transparent conductive layer; and the polarization and alignment distribution of the composite material layer is processed by rubbing.
